(19) United States
(12) Patent Application Publication
(10) Pub. No.: US 2004/0210457 A1
(43) Pub. Date: Oct. 21, 2004

(54) Website messaging system for soliciting volunteers for medical clinical trials

(76) Inventor: Joseph Sameh, Wilmette, IL (US)

Correspondence Address: WELSH & KATZ, LTD, 120 S RIVERSIDE PLAZA, 22ND FLOOR, CHICAGO, IL, 60606, US

(21) Appl. No.: 10/413,642

(22) Filed: Apr. 15, 2003

(51) Int. Cl. G06F 17/60

(52) U.S. Cl. 705/2

(57) ABSTRACT

A method and apparatus are provided for processing a message from a patient for one of a plurality of physicians through a web site. The method includes the steps of providing one or more web pages to the patient from the web site containing indicia of identity for each physician of the plurality of physicians and detecting selection by the patient of a physician of the plurality of physicians. The method further includes the steps of determining an information content of the message and routing the message based upon the determined information content and a predetermined routing criteria provided by the selected physician.

### FIELD OF THE INVENTION

The field of the invention relates to physician/patient contact and more particularly to methods of soliciting volunteers for medical clinical trials.

### BACKGROUND OF THE INVENTION

Medical clinical trials are an important part of the field of medicine. Clinical trials may be used in conjunction with any of a number of medical drugs, devices and procedures.

Clinical trials are procedures that may be implemented after limited approval of a drug or device by the Federal Drug Administration (FDA). Such limited approval may be granted after laboratory research or other studies show that a drug or device is relatively safe and may have therapeutic effect when used under certain conditions.

Typically clinical trials involve the use of the drug or device in the context of volunteers. Clinical trials are usually sponsored by drug companies or medical device makers and are supervised by physicians.

While clinical trials are an important part of the approval process for drugs and medical devices, it is often difficult to solicit volunteers. The public, in general, is often leery of becoming the subject of medical testing.

In order to ensure the objectivity of clinical trials, it is often necessary to solicit volunteers with a great deal of diversity (e.g., in geographic location, ethnic background, age, profession, etc.). However, it is often difficult and expensive to solicit the proper mix of characteristics in volunteers using conventional mass marketing techniques.

One alternative that has been used in the past has been to solicit physicians to participate in the clinical studies and to provide incentives to the physicians to recruit their patients as study volunteers. This approach has not been all that successful in that 86% of all clinical studies finish recruitment at least one month behind schedule according to “CenterWatch Monthly”. One reason for this is that the physician who is typically the recruiter doesn't come in contact with all patients each time they communicate with the physician's office. Less than 10% of phone calls to doctors conclude in contact with the doctor.

The difficulty in making contact often causes physicians who may be willing to participate in clinical studies to be unable to effectively recruit a full complement of volunteers within a timeline of the study. Without a full complement of volunteers, studies become statistically incomplete and therefore less likely to be conclusive in demonstrating any intended result. Because of the importance of clinical studies, a better method is needed for soliciting volunteers for clinical studies.

### SUMMARY

A method and apparatus are provided for processing a message from a patient for one of a plurality of physicians through a web site. The method includes the steps of providing one or more web pages to the patient from the web site containing indicia of identity for each physician of the plurality of physicians and detecting selection by the patient of a physician of the plurality of physicians. The method further includes the steps of determining an information content of the message and routing the message based upon the determined information content and a predetermined routing criteria provided by the selected physician.

### BRIEF DESCRIPTION OF THE DRAWINGS

FIG. 1 is a block diagram of a website messaging system under an illustrated embodiment of the invention;

FIG. 2 is a physician selection screen that may be used by the system of FIG. 1;

FIG. 3 is a classification screen that may be used by the system of FIG. 1;

FIG. 4 is an existing patient screen that may be used by the system of FIG. 1;

FIG. 5 is a new patient screen that may be used by the system of FIG. 1;

FIG. 6 is a pharmacist screen that may be used by the system of FIG. 1;

FIG. 7 is a medical staff screen that may be used by the system of FIG. 1;

FIG. 8 is a priority selection screen that may be used by the system of FIG. 1;

FIG. 9 is a key word entry screen that may be used by the system of FIG. 1; and

FIG. 10 is a routing priority screen that may be used by the system of FIG. 1;

FIG. 11 depicts a clinical trials webpage that may be used by the system of FIG. 1; and

FIG. 12 depicts a clinical trials sign-up sheet that may be used by the system of FIG. 1.

### DETAILED DESCRIPTION OF AN ILLUSTRATED EMBODIMENT

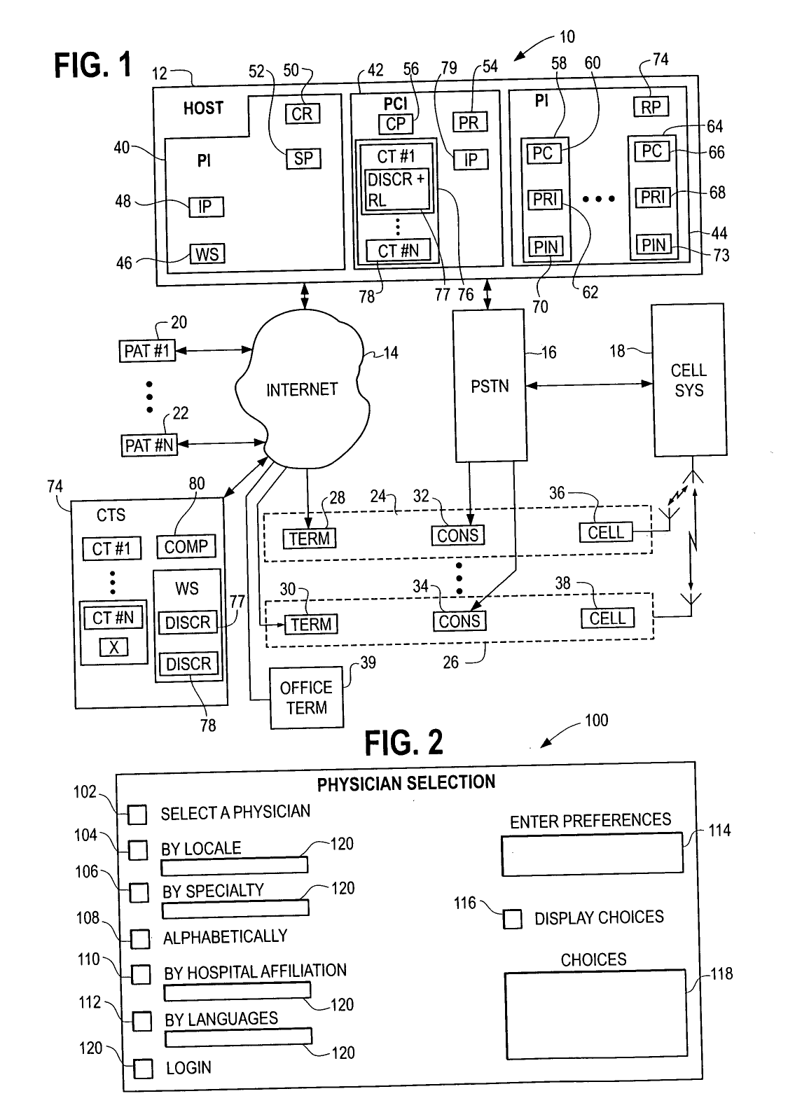

FIG. 1 is a block diagram of a website messaging system 10 shown generally in accordance with an illustrated embodiment of the invention. The website messaging system 10 may be used to forward messages from patients to their attending physicians under any of a number of predetermined message formats and patient conditions specified by the attending physician.

The system 10 may also be used by associates of the physician (e.g., labs, pharmacies, etc.) to forward messages about patients to the attending physician. Because of the flexibility of the system 10 in handling messages the term “patient” or “requestor” is often used herein generically to refer to any of patients, associates of the physician or to other physicians passing messages through the system 10.

The system 10 may include a number of different interfaces 40, 42, 44. A first interface 40 may function as a patient interface that is able to provide information to and receive information from a patient 20, 22. One of the primary functions of the patient interface 40 is to identify a patient's attending physician and to function as an interface between the patient and the identified attending physician from among the many other physicians that may also use the system 10.

A second interface 42 may function as a processing center interface. The processing center interface 42 may function to receive information from the patient 20, 22 and determine a priority of the message.

A third interface 44 may function as the physician interface 44. The physician interface 44 functions to deliver the messages based upon the determined nature of the request and a set of delivery instructions provided by the physician.

The physician interface 44 may include a number of physician's records 58, 64, including one record for each physician using the system 10. Each record 58, 64 may include a physician's priority criteria 62, 68 and also a set of physician's routing instructions 62, 68 for routing requests to the physician.

The physician interface 44 may function to deliver messages to physicians under any of a number of communication formats (e.g., Internet, voice channel through the public switched telephone network (PSTN), voice channel through a cellular system, data through a cellular system, pager, palm pilot etc.). Because of the multiplicity of communication channels through which a request may be delivered, a communication sphere 24, 26 may be defined for each physician.

The communication sphere 24, 26 may be defined in a metaphysical sense as the physical space proximate the physician that may contain one or more communication devices. For example, if a first physician and his associated communication sphere 24 (the physician and communication sphere sometimes referred to hereinafter, together, as the “physician 24”) were located in his office (either in his home or in his clinic), then he may have access to a computer terminal 28, a telephone console 32 and a cell phone 36, all at the same time. In this case, the communication sphere 24 of the first physician may include the computer terminal 28, the telephone console 32 and the cell phone 36, as shown in FIG. 1.

If the physician 24 should leave his office and take his cell phone 36 with him, then the physician's communication sphere 24 would only include the cell phone 36. Further, if the first physician 24 should leave his office and enter the office of a second physician 26, then the communication sphere 24 of the first physician may also include the communication devices 30, 34, 38 that are also within the communication sphere 26 of the second physician.

In order to accommodate the mobile nature of physicians, the physician interface 44 may be easily altered to include the changing range of communication devices located within the communication sphere 24, 26 of the physician. It should also be noted that the physician interface 44 may be altered to include the communication devices subscribed to by the physician or the communication devices of other physicians or non-physicians. In addition, while only two communication sphere 24, 26 are shown in FIG. 1, any number of spheres 24, 26 and any number of communication devices 28, 30, 32, 34, 36, 38 may be accommodated by the system 10.

Turning first to the patient interface 40, an explanation will first be offered of the interface 40 and how it functions to collect relevant information. Following a description of the patient interface 40, an explanation will be provided of the processing center interface 42 and of the physician interface 44.

In order to facilitate the simple and convenient use of the patient interface 40, the interface 40 may allow a patient 20, 22 to contact his physician through a web site (e.g., with a URL of “NeedMyDoctor.com”). Contacts through the web site 46 may be routine (e.g., making an appointment, obtaining a renewal of a prescription, etc.) or on a more urgent basis (e.g., an emergency).

Identification of a patient's physician may be accomplished automatically in the case of an existing patient by storing an identifier of the attending physician as a cookie in a browser of a computer terminal 20, 22 of the patient. In the alternative, new patients may be offered the opportunity to select a physician based upon the needs and preferences of the patient 20, 22.

Upon accessing the web site 46, an identity processor 48 may attempt to identify the patient 20, 22 at the earliest opportunity before the patient 20, 22 transfers any information or leaves any messages during a current session. This may be done because immediate recognition simplifies the interaction and tends to reassure the patient 20, 22.

Identification of the patient 20, 22 may be accomplished by retrieving a URL of the party accessing the web site 46 or by retrieval of any cookies present within the browser of the accessing party 20, 22. In either case, the URL or cookies may be compared with the contents of a set of customer records 50 to identity any physicians that the patient 20, 22 may have previously selected.

In either case, a screen (web page) 100 (FIG. 2) may be downloaded to a browser of the patient or other requestor 20, 22. If the patient 20, 22 has previously used the system 10 and has previously selected a physician, then any selected physicians may be displayed within a CHOICES box 118.

If the patient 20, 22 has previously used only a single physician, then a name, image and biography of the physician may be displayed in the choice box 118. The patient 20, 22 may select this physician by activating a SELECT A PHYSICIAN button (softkey) 102 or by activation of an ENTER button on his terminal 20, 22.

If the patient 20, 22 has previously used or selected more than one physician, then a list of the names of previously selected physicians may be displayed in the CHOICES box 118. The patient 20, 22 may either select a physician from among those displayed in the CHOICES box 118 or select yet another physician by activation of one or more criteria selection boxes 104, 106, 108, 110, 112. If the patient 20, 22 selects from among the list of previously selected physicians within the box 118, then a name and image of the physician may be displayed and the patient 20, 22 may proceed as described above.

If the patient 20, 22 chooses to select another physician, then he may select the other physician based upon any of a number of different criteria (e.g., locale, medical specialty, hospital affiliation, language ability, etc.). Further, the patient 20, 22 may refine his search by using a preferences window 114.

For example, the patient 20, 22 may enter an “A” in the preferences window 114 and activate a LOCALE button 120. Alternatively, the patient 20, 22 may activate the LOCALE button 104, enter an “A” in the box 114 and select the DISPLAY CHOICES button 116. In response, a selection processor 52 within the patient interface 40 may provide the patient with a set of choices on locale that begin with “A” (e.g.: Alabama; Alaska; Albany, New York, etc.).

The patient 20, 22 may make a selection and proceed to another search criteria. Upon making a selection, the selection may appear in a criteria display 120 associated with the criteria.

If the patient 20, 22 should then activate the BY HOSPITAL AFFILIATION button 110, then a list of hospitals in the selected locale may be displayed in the CHOICES box 118. As above, the patient 20, 22 may make a selection and the selection may appear in the box 120 associated with the selected criteria.

The patient 20, 22 may then select a specialty and, possibly a language preference. The patient 20, 22 may then select an ALPHABETICALLY button 108 to view a list of physicians under the combination of criteria chosen. The patient 20, 22 may select a physician from the list shown in the CHOICES area 118 and activate the SELECT A PHYSICIAN button 102 to complete the process.

As a much simpler alternative, the patient may simply enter a physician's name in the ENTER PREFERENCES box 113 and activate the SELECT A PHYSICIAN box 102. The name and image of the physician may appear in the CHOICES box 118. The patient 20, 22 may then review his choice and then activate the SELECT A PHYSICIAN box 102 a second time to complete selection of the physician.

The ability to enter a physician's name is a tremendous advantage for people who are traveling and experience a medical problem. In this case, the requestor 20, 22 may simply go to any computer and access the website 46 remotely.

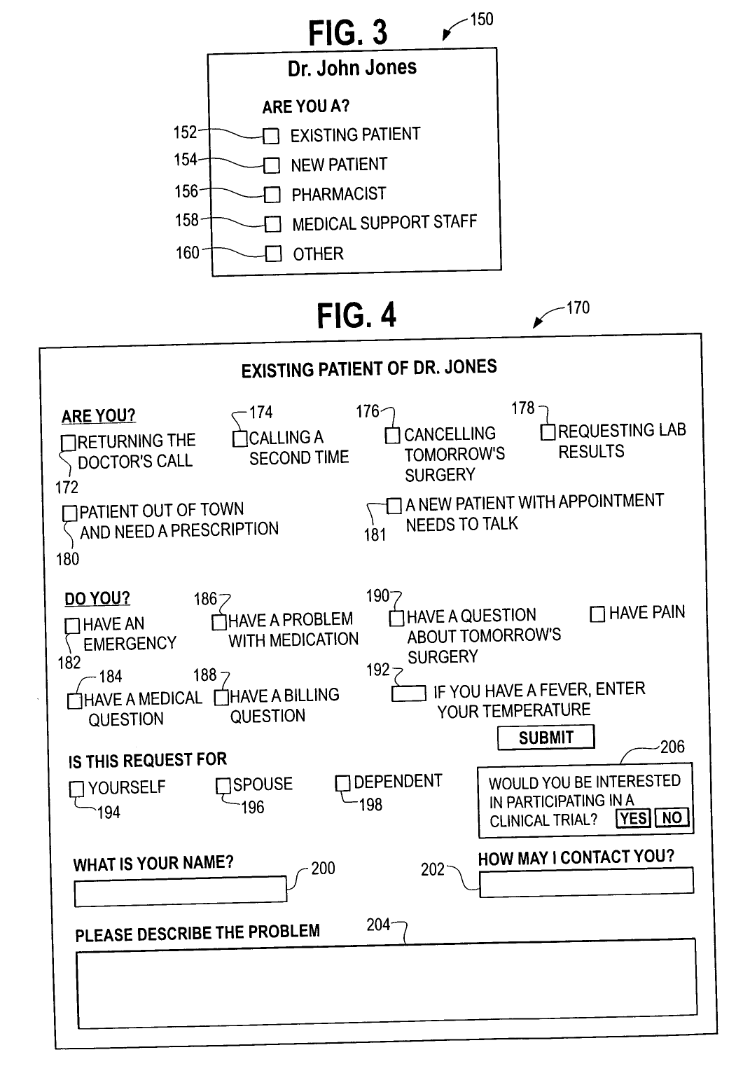

Following selection of a physician, the web page 150 (FIG. 3) may be downloaded to the patient 20, 22. Included within the web page 150 may be a number of classification buttons 152, 154, 156, 158, 160 for each message. While any method of classification may be used one method divides the messages according to whether the source is an existing patient, a new patient, medical support staff or other. Activation of an EXISTING PATIENT button 152 may be used to indicate that the patient 20, 22 is already under the care of the physician. Activation of a NEW PATIENT button 154 may be used to indicate that the patient 20, 22 has never seen the physician. Activation of the PHARMACIST button 156 may be used to indicate that the requester 20, 22 may be a pharmacist with a question about a prescription. Activation of the MEDICAL SUPPORT STAFF button 158 may indicate a message from another physician or a message from a person providing support services to the physician. Finally, activation of the OTHER button 158 may be used for any other purpose selected by the physician.

If the patient 20, 22 should activate the EXISTING PATIENT button 152, then the appointment request screen 170 of FIG. 4 may be downloaded to the patient 20, 22. Within the screen 170, a first set of boxes (softkeys) 172, 174, 176, 178, 180, 181 may be provided for entering an overall reason for the message. A second set of boxes 182, 184, 186, 188, 190, 192 may be provided for determining a physical state of the patient. A text entry window 192 may be provided for entry of a patient temperature.

Another text box 200 may be provided for entry of a name of the requestor 20, 22. A text box 202 may also be provided for entry of a communication path (e.g., telephone number, e-mail address, pager number, etc.) through which the physician can reach the requestor 20, 22. The requestor 20, 22 may also be able to identify through a set of softkeys 194, 196, 198 whether the requestor is the patient or whether the patient is a relative. A text box 182 may be provided for entry of a description of the problem.

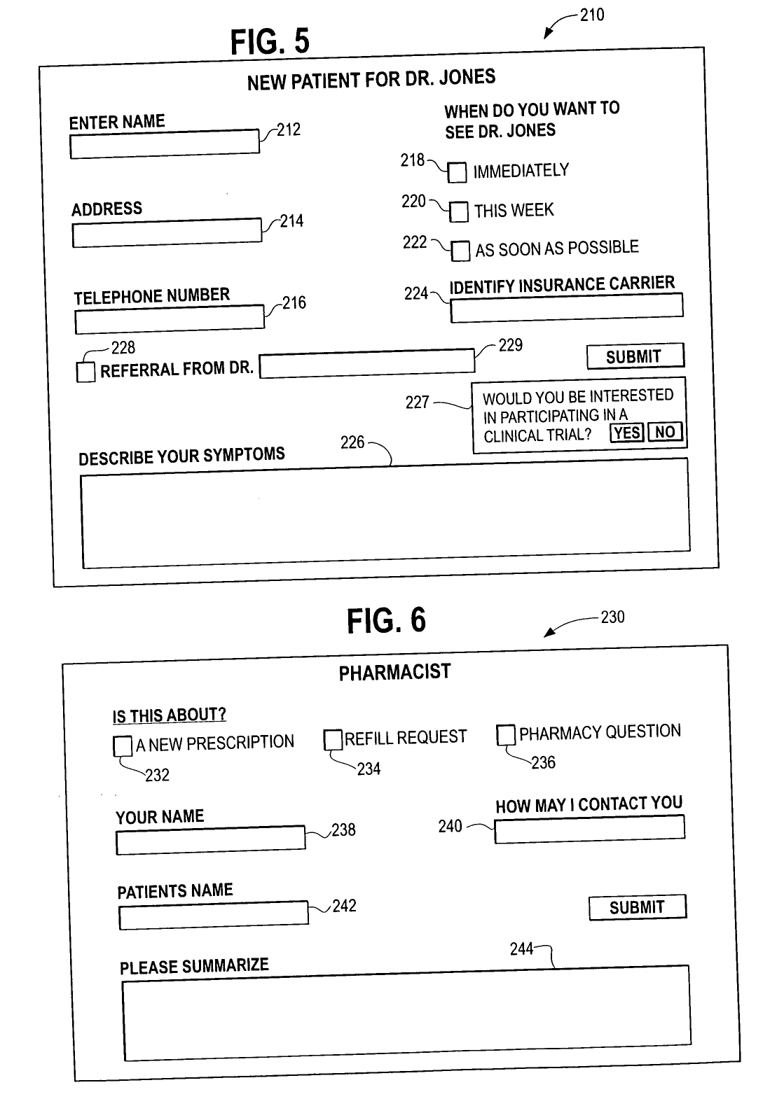

If the patient 20, 22 should activate the NEW PATIENT softkey 154, then the patient appointment screen 210 of FIG. 5 may be downloaded to the requestor 20, 22. Text boxes 212, 214, 216 may be provided for entry of a name, address and contact information of the patient. A softkey 228 and textbox 229 combination may be used to identify the patient as a referral and the source of the referral. Selection buttons 218, 220, 222 may be provided for scheduling an appointment. A text box 224 may be provided for entry of insurance information. Finally, a large text box 226 may be provided for entry of descriptive information regarding the reason for the appointment.

If the requestor 20, 22 should activate the PHARMACIST softkey 156 on FIG. 3, then the screen 230 of FIG. 6 may be downloaded to the requestor 20, 22. Within the screen 230, the requestor 20, 22 may be provided with text boxes 238, 240 for identification of the requestor and to enter contact information. A set of softkey boxes 232, 234, 236 may be provided for the requestor to differentiate between questions about new prescriptions, refills and general pharmacy questions.

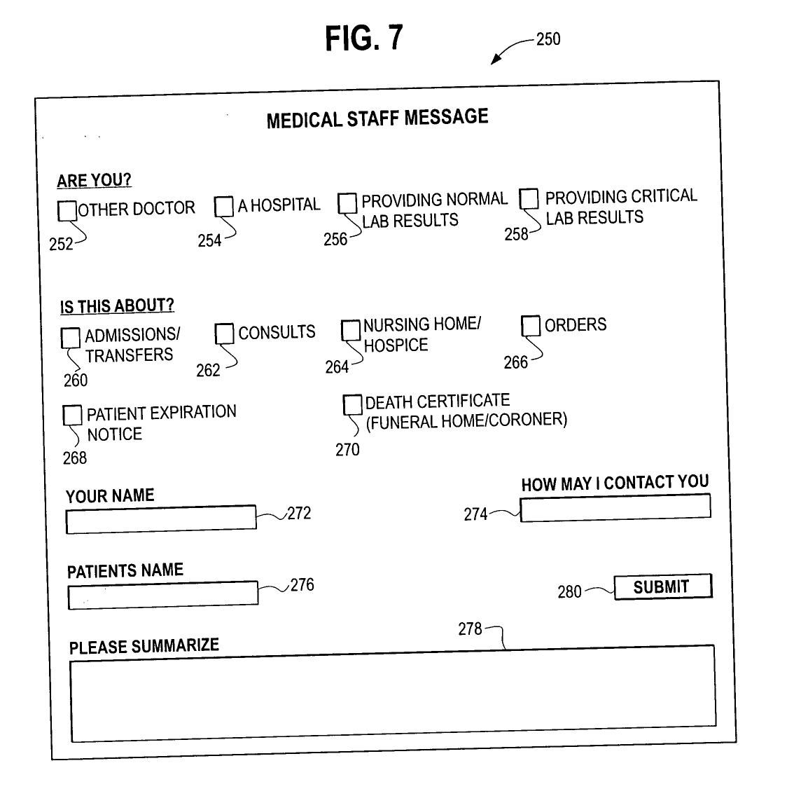

If the requestor 20, 22 should activate the MEDICAL SUPPORT STAFF button 158, then the screen 250 of FIG. 7 may be downloaded to the requestor 20, 22. Within the screen 250, the requestor 20, 22 may be asked to enter his name and contact information in one set of boxes 272, 274. Another set of boxes 252, 254, 256, 258, 260, 262, 264, 266, 268, 279 may be provided for entry of a context of the request.

In addition, a text box 276 may be provided for entry of a patient's name. Another text box 278 may be provided for entry of a message regarding the patient. A SUBMIT button 280 allows the requestor 20, 22 to return the message to the system 10.

If the requestor 20, 22 should activate the OTHER box 158, then a single blank text box may be downloaded. The OTHER button 158 may be used for any of a number of purposes as described in more detail below.

Upon completion of selection of a physician and of the entry of information through the text boxes of FIGS. 3-7, the message may be transferred to the processing center interface 42. Within the processing center interface 42, a content processor 56 may process each message to determine a nature and content of the request based upon the information elements provided through the web pages (e.g., the identity of the requestor, any classification information provided through the classification buttons and any text information received through the text boxes).

Based upon the determined nature and content of the request, a relative importance may be assigned to the request, based upon a subjective criteria provided by the physician. The criteria is necessarily subjective because the relative importance of information elements varies from one physician's practice to another physician's practice and in accordance with the preferences of one physician over another physician.

For example, physicians with a practice limited to surgery may only classify messages from hospitals or other surgeons or patients with post operative problems as significant enough to justify an expedited message to the physician. Other messages to the surgeon may be regarded as much less important.

In the alternative, a physician with a practice limited to pediatric care may only consider children with high fevers, broken bones or severe bleeding as important. Other requests related to less severe trauma may be considered to be less important. Further the criteria for routing messages to a physician may be changed based upon the time of day.

For example, during normal office hours, all messages may be routed to a nurse or other assistant at a clinic or hospital where the physician is normally to be found during those hours. After normal office hours, messages may be routed to the physician only when the physician is on call. When the physician is not on call, any requests to the physician may be automatically routed to another designated physician.

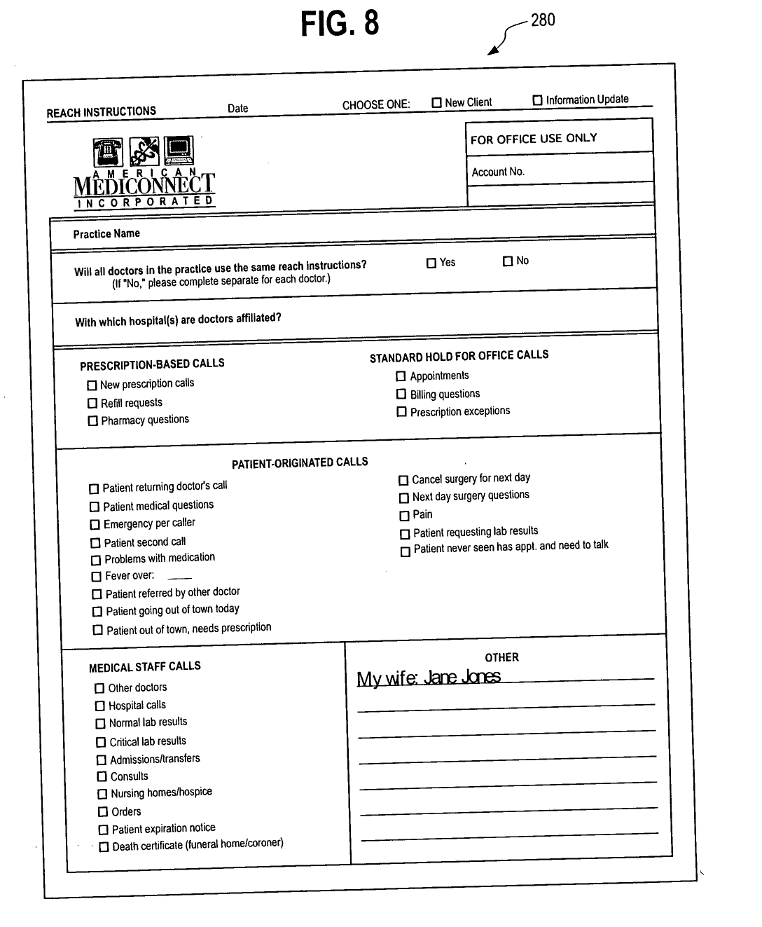

Based upon the nature of the request, the content processor 56 may route the message, by comparing an information content with a set of threshold values provided by the physician. FIG. 8 provides a screen 280 that may be downloaded to a terminal 28, 30 of a physician 24, 26 for purposes of setting threshold values for forwarding messages. The screen 280 may be downloaded to a physician during initial registration with the system 10 or at any time thereafter to change the routing format.

The screen 280 of FIG. 8 may be used by the physician to establish a multi-level message forwarding methodology. Under one embodiment, the box shown along the left side of each subject matter listing in screen 280 may be a text box where a number value indicating priority may be explicitly entered. For purposes of simplicity, the system 10 will be described as being based upon a two-level system of priorities. However, any number of priority levels could be used.

Also, for purposes of simplicity, the use of the screen 280 will be described using a system of default levels. Instead of entering a number in the box, the boxes may be used as softkeys. If the softkey is activated by the physician, then the subject matter of that softkey will be given the highest priority. If the softkey is not activated, then the subject matter will be given the second, lower level of priority.

At a highest, first level of importance, messages may be routed directly to a physician's sphere 24, 26. At the second level, requests may be routed to a secondary destination (e.g., an office of the physician).

For example, checking the box in the upper left corner (labeled “New prescription calls”) would result in all messages from pharmacists about new prescriptions being given the highest priority and routed directly to the physician. Further, checking the box in the bottom of the right-side (labeled “Patient never seen has appt. and need to talk”) would result in messages from first time patients begin routed on the first level.

In general, the solicitation and processing of messages from requestors 20, 22 within the content processor 56 may be controlled by a physician's criteria obtained by the system 10 through screen 280 and stored in a file 60, 66 for each physician. Once a physician 24, 26 has identified a routing criteria (e.g., using screen 280), the content processor 56 may retrieve the routing criteria for that physician 24, 26 and use the criteria for message routing.

As each webpage 150, 170, 200 is completed and returned to the system 10, the content processor 56 may examine the content of the webpage 150, 170, 200 under the criteria provided by the associated physician 24, 26. A determination of the nature and importance of the message may occur on any of a number of different levels.

On a first level, the processor 56 may determine the type of message based upon the information elements provided through screens 170, 210, 230, 250. Following a determination of the type of message, the content processor 56 may perform an element-by-element comparison between selected items for that message type on screen 280 and the content of the message.

The message type of STANDARD HOLD FOR OFFICE CALLS would always be classified as a low priority unless the physician indicated otherwise. If the physician has selected “Appointments”, then messages from new patients where the softkey 154 is activated would be given a high priority. The selections for “Billing questions” and “Prescription exceptions” may be given similar treatments.

Messages from patients may be processed somewhat differently. For example, a physician may not only select the option “Fever over ______”, but may also specify a priority limit for the fever. Detection may be accomplished by a comparison of the numeric value entered through the text box 192 and the threshold value provided by the physician. Alternatively, the physician may specify any fever within one week post operatively.

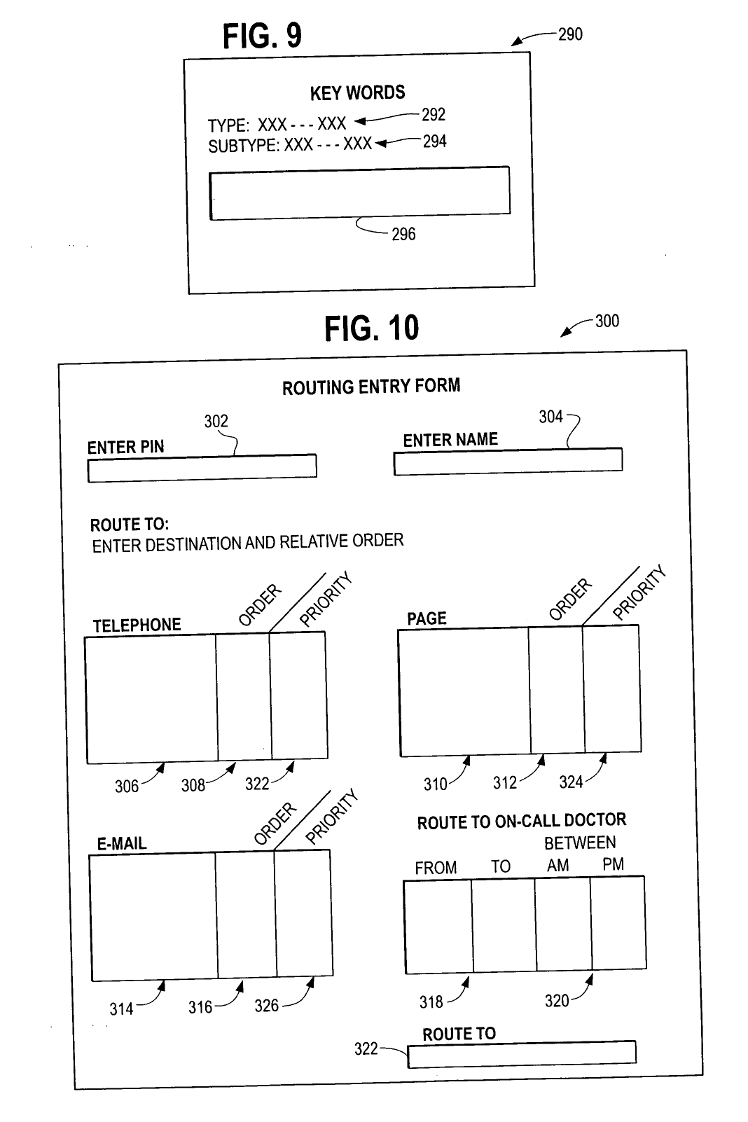

On another level, the physician 24, 24 may also set a criteria for message routing based upon key word searching using words entered through any of the text boxes 202, 204, 226, 238, 242, 244, 272, 272, 276, 278. For example, the physician 24, 26 may go to screen 280 of FIG. 8 and double click on any element or sub-element to bring up a text box associated with that element. For example, the physician 24, 26 may double click on the “OTHER” category on screen 280. In response, the text box 290 of FIG. 9 may be downloaded to the physician's terminal 28, 30. Within the text box 290, a first line 292 may indicate the type of text box as being “OTHER”. Since the “OTHER” category does not have a sub-element, the second line 294 may be blank.

Upon entering the text box 290, the physician 24, 26 may enter his wife's name (e.g., “Jane Jones”) or some other word identifying his wife. Entry of his wife's name as a criteria for the “OTHER” category allows any message sent under the “OTHER” classification and that includes his wife's name or identifier to be given a high routing priority.

To use the facility, the physician's wife would enter the web site 46, type her husband's name in text box 114 and activate “SELECT A PHYSICIAN”. On the next downloaded screen 150, the wife would select “OTHER”. In response, a blind screen would appear within which the physician's wife may type “From: Jane Jones” and a message. Upon receiving the message, the content processor 56 would compare the key words “Jane Jones” with the content of the message and recognize the matching words “Jane Jones” present in the message header. Based upon the match, the content processor 56 would route the message at the highest priority level.

Alternatively, the physician may also click on “PATIENT-ORIGINATED CALLS” on screen 280 and enter a patient's name. Based on key word searching, any message from that patient would be routed at the highest priority.

The use of key word searching allows a physician to customize call routing for any time period (e.g., 2 hours, 2 days, permanently, etc.) to meet the needs of critically ill patients. Alternatively, if the physician is part of a surgical team waiting for a transplant donor, key word searching could be used to automatically identify messages from other members of the surgical team.

Once the content processor 56 determines an information content and priority level of a message, the content processor 56 may transfer the message to a routing processor 72 within the physician's interface 44. Within the physician's interface 44, the routing processor 72, may retrieve a set of routing instructions 68 based upon the priority level determined by the content processor 56.

Located within the routing instructions 68 may be a prioritized list of communication devices within the physician's communication sphere 24, 26. Messages may be routed to the physician 24, 26 based upon the entries within the prioritized list.

FIG. 10 depicts a routing webpage 300 that may be downloaded from the web site 46 to a terminal 28, 30 of the physician. The routing webpage 300 may be accessed by first accessing the physician identification webpage 100 (FIG. 2) and activating LOGIN softkey 120.

Within the webpage 300, the physician may first be required to enter his personal identifier number (PIN) into a first box 302. Upon entering his PIN number the terminal 28, 30 may upload the PIN to the routing processor 72 where the PIN is compared with the PINs 70, 73 of other physicians using the system 10.

If a match is found, the routing processor 72 may download a name of the physician to be displayed in a first box 304 and a current content of the physician routing instructions 62, 68 to be displayed in other boxes 306, 310, 314.

Included with each routing destination is an ordering number 308, 312, 316 and priority ranking 322, 324, 326. The ordering number indicates the relative position of the routing destination in the routing list for any particular priority level. For example, at the highest priority level, if the physician wishes to be paged first, then the pager number would appear at a top of a list in box 310 with a number “1” shown opposite the pager number in an order list 312 and a “1” in the priority ranking. If the physician wishes to simultaneously receive a hardcopy of the message on his computer 28, 30, then an e-mail address of his computer may appear on the top of list in an e-mail box 314 opposite another number “1” in the order box 316 and a “1” in the priority ranking. Once the physician downloads the screen 300, he may make new entries, delete old entries or change the order at will.

In addition to setting up a routing list, the physician 24, 26 may also set up a schedule when he/she is not to receive messages (i.e., the physician is not on call). As shown, the physician simply enters his dates and hours when the physician is not on call and when calls should be routed to another physician. The entry of time periods into boxes 318, 320 simply causes messages to be routed to an alternate physician in an on call list maintained within the system 10. An identifier of the alternate physician may be entered into a “ROUTE TO” text box 322.

Delivery of the messages may occur under any of a number of different formats. For example, if the physician's computer 28, 30 is the destination of a message, then the delivered message may have the same format as shown in FIGS. 2-7. Alternatively, the format of FIGS. 2-7 may be changed to delete unnecessary information.

If the destination is a cell phone or a telephone, then a voice synthesizer may be used to present the messages of FIGS. 2-7 under a predefined audio format. Alteration of the call list based upon screen 300 may also be accomplished using a telephone, the voice synthesizer and keypad selection on the telephone.

Once a message has been delivered to the physician 24, 26, the routing processor 72 may send a message back to the patient interface 40 and patient 20, 22 confirming receipt of a high priority message by the physician. Where the physician responds to the patient's message through the system 10, the routing processor 72 may also calculate an average time for the physician to respond. In such cases, the routing processor 72 may also include an estimate of the expected time for the physician to respond in the message transferred to the patient 20, 22.

In another embodiment of the invention, the website messaging system 10 may be used by sponsors 74 to solicit volunteers for clinical trials. The sponsors 74 may be given access to the websites 10 to solicit volunteers in exchange for certain financial incentives to the physicians. The physicians may either work directly for the sponsors 74 or offer access and use of their websites 10 in exchange for predefined compensation.

The sponsors 74 may be any entity with an interest in performing a clinical trial (e.g., a drug company, medical appliance manufacturer, medical research organization, etc.). Moreover, the sponsors 74 do not necessarily need to be directly involved in medical research but need only be a responsible party with an interest in the outcome of a study (e.g., Women's Health Initiative, STAR, etc.).

It should be noted in passing, that any number of sponsors 74 may solicit volunteers through the website 10. It should also be noted that any one sponsor 74 may solicit volunteers for any number of trials through a single website 10.

Further, the sponsor 74 may solicit volunteers using the website 10 in any manner that is not inconsistent with the website's intended use as a doctor-patient interface. Under a first embodiment of the invention, an invitation to participate in a clinical trial is provided only as a passive invitation (e.g., a softkey) optionally displayed on a patient appointment screen downloaded from the physician's website 10. It is not provided as an unsolicited text ad, pop-up ad, banner ad, surround session ad or interstitial ad. The softkey is optional because the display of the softkey is dependent only upon the occupancy of any clinical trial offered through the website 10. For example, in the case where only a single trial is offered through the website 10, one patient may receive the softkey if the clinical trial has not yet reached its planned size, yet the next patient may not receive the softkey if the previous patient was accepted for entry into the trial.

Under a second embodiment, activation of the EXISTING PATIENT softkey 152 or NEW PATIENT softkey 134 causes the physician's website 10 to send a notification packet to the clinical trial sponsor 74. The notification packet may contain at least an identifier of the website 10 and a URL of the patient 20, 22. The trial sponsor 74 may then search for any clinical trials that are being conducted in the area serviced by the website 10. If any are found, then the trial sponsor 74 may download an unsolicited invitation directly to the patient 20, 22. The unsolicited invitation may be provided under any of a number of different formats (e.g., unsolicited text ad, pop-up ad, banner ad, surround session ad, interstitial ad., etc.).

It should be noted that use of the website 10 is not limited to existing or new patients of any physician controlling the website 10. For example, people who specialize in volunteering for clinical trials may visit any website 10 to volunteer for a clinical trial.

Turning now to operation of the website 10 of FIG. 1, an explanation will first be offered of the methods by which volunteers may be solicited for clinical trials. Following the explanation of the solicitation of volunteers, the explanation will be expanded to include how information from volunteers may be used to limit further solicitation of additional volunteers once a study has met its goals in terms of the number of subjects necessary to complete the study.

Under the first embodiment, the website 10 may maintain a clinical trials list (CTL) 76 within a memory of the processing center interface 42. The CTL 76 may contain a respective file 77, 78 containing the details of each clinical study that still needs volunteers from the one or more sponsors 74.

The CTL 76 may be periodically updated by the sponsor(s) 74. Some clinical trials 77, 78 may be deleted while other new clinical trials 77, 78 may be added.

As each patient webpage 170, 210 is downloaded for the benefit of a patient 20, 22, a clinical trial volunteer solicitation box 206, 227 may be included within the screen 170, 210. Within the box 206, 227, the patient 20, 22 may express an interest in volunteering by activating a YES button or reject the offer by activating the NO button.

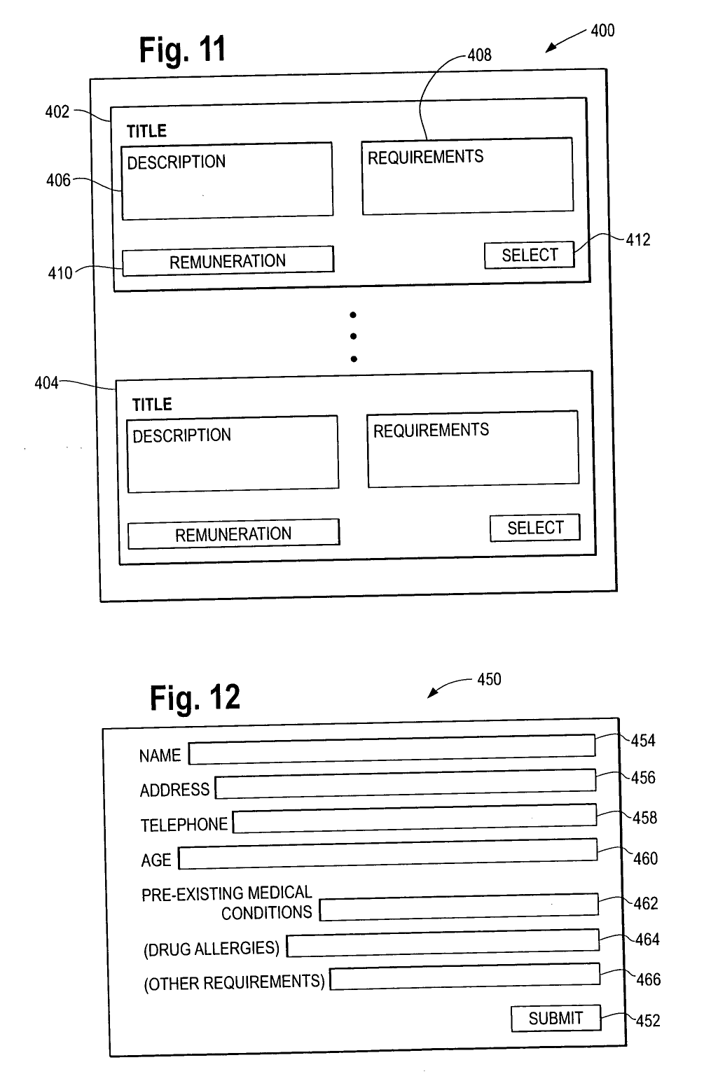

If the patient 20, 22 should activate the YES button, then an interface processor 79 within the processing center interface 42 may retrieve a set of files 77, 78 from memory 76 and incorporate the information into the webpage (screen) 400 of FIG. 11. The screen 400 may then be downloaded to the patient 20, 22.

As shown in FIG. 11, each clinical trial may occupy a predetermined space 402, 404 within the screen 400. For example, the content of a first file 77 that had previously been downloaded to the website 10 from the sponsor 74 may occupy a first window 402 of the screen 400, while a second file 78 may be shown in a second window.

Within each window 402, 404 may be a title of a respective clinical trial 77, 78, a description of the trial 406, a requirements list 408, an indication of any remuneration 410 for participating in the trial and a SELECT button 412. The description 406 may include a description of the type of clinical trial and the objectives of the trial. The requirements list 408 may include a description of any minimum requirements (e.g., age, physical conditions, etc.) and any exclusionary conditions that must be met for being considered for the trial. Remuneration 410 may be a description of any payment or other compensation, including medication and health care, that may be available for successfully completing a trial. The SELECT button 412 may be used by a patient 20, 22 to enroll in a clinical trial.

The SELECT button 412 associated with each description may operate in either of two different methods. Under a first method each SELECT button 412 may incorporate a hyperlink directly to the respective study. Under a second method, the SELECT button 412 may simply transfer a message back to the website 10 including an identifier of the clinical trial 402, 404.

Upon activating the select button 412, the interface processor 79 may receive the identifier 402, 404 and compose a trial selection message to the appropriate sponsor 74 that includes at least an identifier of the file 77, 78 selected by the patient 20, 22, a URL of the patient 20, 22 and an identifier of the website 10. Once composed, the interface processor 79 may transfer the selection message to the sponsor 74.

Upon receiving the selection message either from the processor 79 or directly from the patient 20, 22, the sponsor 74 may download the sign-up webpage 450 of FIG. 12. Within the sign-up webpage 450, the patient 20, 22 may be asked to provide sufficient personal information as to allow the sponsor 74 to evaluate the suitability of the patient 20, 22 for the trial.

Upon receiving the webpage 450, the patient 20, 22 may enter his/her personal information in the appropriate interactive box 454, 456, 458, 460, 462, 464, 466. At least some boxes 464, 466 may be reserved for information directed to the precise type of trial involved. For example, a clinical trial for a drug that reduces the recurrence of heart attacks may include a box 464, 466 and associated question asking the patient 20, 22 for the number and dates of any prior heart attacks.

Once the patient 20, 22 has finished filling out the sign-up webpage, the patient 20, 22 may activate a SUBMIT softkey 452. Upon activation of the SUBMIT key, the information of the webpage 450 may be transferred to the sponsor 74.

As a further alternative, instead of being a hyperlink, each SELECT button 412 may be replaced by a telephone toll-free 800 number that a patient may call to sign up for a clinical trial. Where a patient 20, 22 calls the toll-free number, an operator may ask questions and receive information sufficient to complete a sign-up webpage 450 to qualify the patient 20, 22 for a clinical trial. The operator, in turn, may transfer the completed webpage 450 to the sponsor 74.

Once received by the sponsor 74, the information of the sign-up webpage 450 is compared within a comparison processor 80 with a set of technical requirements of the clinical trial. If the information provided by the patient 20, 22 meets the requirements for the clinical trial, then the sponsor 74 may add the patient 20, 22 to a list of accepted volunteers for the trial. The list may be maintained by the sponsor 74 or the by the physician within the website 10. Where the list is maintained by the physician, the sponsor 74 may simply download an identifier of the accepted volunteer to the website 10 while retaining the acceptance of the volunteer as a raw number for accounting purposes.

In addition to entering the patient 20, 22 into the list of volunteers for a particular trial, the sponsor 74 may also decrement the number of additional volunteers needed to complete the trial. When the number of volunteers for a trial has reached the minimum or maximum number (either for the entire trial or only for the locale serviced by the website 10, then the sponsor 74 may download a set of commands to the interface processor 79 to delete the file 77, 78 for the trial from memory 76.

Under the second embodiment, the solicitation of volunteers may occur by spontaneously posting invitations to any patient 20, 22 that visits the website 10. The invitations may occur as popups of invitation boxes 206, 227 (or 400) in conjunction with delivery of an initial webpage 170, 210 or after a predetermined time period intended to allow the patent time to complete any communication with his/her physician.

A specific embodiment of a method and apparatus for routing physician messages through a website has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention, any and all modifications, variations, or equivalents that fall within the true spirit and scope of the basic underlying principles disclosed and claimed herein.

1. A method of recruiting human test subjects for clinical trials, such method comprising the steps of:
providing a plurality of websites for arranging appointments between physicians and patients;
determining whether a clinical study at a location of a website of the plurality of websites still needs volunteers; and
if the clinical study still needs volunteers, then downloading an invitation to enter the clinical study to patients accessing the website.

2. The method of recruiting human test subjects as in claim 1 further comprising downloading an appointment request webpage from the website to a patient accessing the website.

3. The method of recruiting human test subjects as in claim 1 wherein the step of downloading the appointment request webpage further comprises displaying the invitation as a clinical trial invitation softkey on the appointment request webpage downloaded to the patient.

4. The method of recruiting human test subjects as in claim 3 further comprising appending text to the clinical trial invitation softkey announcing the objective of the clinical trial and inviting the patient to press the softkey to obtain more information.

5. The method of recruiting human test subjects as in claim 3 wherein the step of displaying the invitation as a clinical trial invitation softkey on an appointment request webpage downloaded to the patient further comprises sending a notification packet to a clinical trial sponsor when the patient activates the softkey.

6. The method of recruiting human test subjects as in claim 1 further comprising sending a notification packet to a clinical trial sponsor when the patient accesses the website.

7. The method of recruiting human test subjects as in claim 1 further comprising downloading a description and requirements list of the clinical study to the patient.

8. The method of recruiting human test subjects as in claim 7 wherein the step of downloading a description and requirements list of the clinical study to the patient further comprises downloading an interactive sign-up window to the patient.

9. The method of recruiting human test subjects as in claim 8 wherein the step of downloading an interactive sign-up window to the patient further comprises receiving personal data from the patient by the clinical trial sponsor via operation of the interactive sign-up window.

10. The method of recruiting human test subjects as in claim 9 wherein the step of receiving personal data from the patient via the interactive sign-up window further comprises comparing the personal data from the patient with a set of requirements for the clinical trial and accepting the patient as a volunteer for the clinical trial when the personal data from the patient meets the criteria provided by the set of requirements for the clinical trial.

11. The method of recruiting human test subjects as in claim 10 wherein the step of accepting the patient as a volunteer for the clinical trial further comprises determining whether the clinical trial still needs additional volunteers.

12. An apparatus for recruiting human test subjects for clinical trials, such apparatus comprising:
means for providing a plurality of websites for arranging appointments between physicians and patients;
means for determining whether a clinical study at a location of a website of the plurality of websites still needs volunteers; and
means for downloading an invitation to enter the clinical study to patients accessing the website when the clinical study still needs volunteers.

13. The apparatus for recruiting human test subjects as in claim 12 further comprising means for downloading an appointment request webpage from the website to a patient accessing the website.

14. The apparatus for recruiting human test subjects as in claim 12 wherein the means for downloading the appointment request webpage further comprises means for displaying the invitation as a clinical trial invitation softkey on the appointment request webpage downloaded to the patient.

15. The apparatus for recruiting human test subjects as in claim 14 further comprising means for appending text to the clinical trial invitation softkey announcing the objective of the clinical trial and inviting the patient to press the softkey to obtain more information.

16. The apparatus for recruiting human test subjects as in claim 14 wherein the means for displaying the invitation as a clinical trial invitation softkey on an appointment request webpage downloaded to the patient further comprises means for sending a notification packet to a clinical trial sponsor when the patient activates the softkey.

17. The apparatus for recruiting human test subjects as in claim 12 further comprising means for sending a notification packet to a clinical trial sponsor when the patient accesses the website.

18. The apparatus for recruiting human test subjects as in claim 12 further comprising means for downloading a description and requirements list of the clinical study to the patient.

19. The apparatus for recruiting human test subjects as in claim 18 wherein the means for downloading a description and requirements list of the clinical study to the patient further comprises means for downloading an interactive sign-up window to the patient.

20. The apparatus for recruiting human test subjects as in claim 19 wherein the means for downloading an interactive sign-up window to the patient further comprises means for receiving personal data from the patient by the clinical trial sponsor via operation of the interactive sign-up window.

21. The apparatus for recruiting human test subjects as in claim 20 wherein the means for receiving personal data from the patient via the interactive sign-up window further comprises means for comparing the personal data from the patient with a set of requirements for the clinical trial and accepting the patient as a volunteer for the clinical trial when the personal data from the patient meets the criteria provided by the set of requirements for the clinical trial.

22. The apparatus for recruiting human test subjects as in claim 21 wherein the means for accepting the patient as a volunteer for the clinical trial further comprises means for determining whether the clinical trial still needs additional volunteers.

23. An apparatus for recruiting human test subjects for clinical trials, such apparatus comprising:
a plurality of websites for arranging appointments between physicians and patients;
a processor adapted to determine whether a clinical study at a location of a website of the plurality of websites still needs volunteers; and
an interface processor adapted to download an invitation to enter the clinical study to patients accessing the website when the clinical study still needs volunteers.

24. The apparatus for recruiting human test subjects as in claim 23 further comprising an appointment request webpage downloaded from the website to a patient accessing the website.

25. The apparatus for recruiting human test subjects as in claim 24 wherein the appointment request webpage further comprises a clinical trial invitation softkey displayed on the appointment request webpage downloaded to the patient.

26. The apparatus for recruiting human test subjects as in claim 25 further comprising text appended to the clinical trial invitation softkey announcing the objective of the clinical trial and inviting the patient to press the softkey to obtain more information.

27. The apparatus for recruiting human test subjects as in claim 25 wherein the clinical trial invitation softkey on an appointment request webpage downloaded to the patient further comprises a notification packet sent to a clinical trial sponsor when the patient activates the softkey.

28. The apparatus for recruiting human test subjects as in claim 23 further comprising a notification packet sent to a clinical trial sponsor when the patient accesses the website.

29. The apparatus for recruiting human test subjects as in claim 23 further comprising a description and requirements list of the clinical study downloaded to the patient.

30. The apparatus for recruiting human test subjects as in claim 29 wherein the description and requirements list of the clinical study to the patient further comprises an interactive sign-up window downloaded to the patient.

31. The apparatus for recruiting human test subjects as in claim 30 wherein the interactive sign-up window further comprises a comparator provided by the sponsor and adapted to compare the personal data from the patient with a set of requirements for the clinical trial and to accept the patient as a volunteer for the clinical trial when the personal data from the patient meets the criteria provided by the set of requirements for the clinical trial.

32. A method of recruiting human test subjects for clinical trials, such method comprising the steps of:
providing a plurality of websites for arranging appointments between physicians and patients;
determining a location of each website of the plurality of websites;
determining whether a clinical study at a location of each website still needs volunteers; and
if the clinical study still needs volunteers, then downloading an invitation to enter the clinical study to patients accessing the website.

33. A method of recruiting human test subjects for clinical trials, such method comprising the steps of:
providing a plurality of websites for arranging appointments between physicians and patients;
detecting access to a website of the plurality of websites by a patient of the physician's patients;
determining a location of the website;
determining whether a clinical study at the location of the website still needs volunteers; and
if the clinical study still needs volunteers, then downloading an invitation to enter the clinical study to the patient.
